(19) United States
(12) Patent Application Publication
(10) Pub. No.: US 2002/0077971 A1
(43) Pub. Date: Jun. 20, 2002

(54) Bank-based international money transfer system

(76) Inventor: Dale H. Allred, Provo, UT (US)

Correspondence Address: Angus C. Fox, III, 4093 N. Imperial Way, Provo, UT, 84604-5386, US

(21) Appl. No.: 09/738,357

(22) Filed: Dec. 16, 2000

(51) Int. Cl. G06F 17/60

(52) U.S. Cl. 705/39

(57) ABSTRACT

The present invention constitutes a system and method by means of which individuals living in the United States may transfer money rapidly, securely, and inexpensively to other individuals in a foreign country without the use of an international bank wire transfer. The system is designed to benefit foreign expatriates who have a need to send money to family members who still reside abroad. The system, which is run by a managing company having associates in both the U.S. and in the foreign countries to which transfers are made, employs a network of U.S. based banks and a network of foreign based banks. For a preferred embodiment of the transfer process, a managing company is established to administer the process, the company having at least one agent in the U.S. and at least one agent in a foreign country that is the target of money transfers. Potential transferors are provided with a book of deposit slips which identify an account associated with the managing company at a U.S. bank and a sub-account associated with the transferor, so that the transferor may make a cash deposit at a branch of the U.S. bank for transfer to the foreign country. For each deposit made in the U.S., a corresponding amount in the currency of the foreign country is deposited into an account identified by the transferor and owned by his designated transferee at a bank in the foreign country, the foreign deposit being made by the managing company, using information provided to the managing company by the transferor and deposit information provided by the U.S. banks.

### FIELD OF THE INVENTION

This invention relates to methods for transferring money from one location to another and, more particularly, to methods for securely transferring money across international borders.

### BACKGROUND OF THE INVENTION

Every year, millions of Mexicans and other Latin-Americans, mainly of working age, attempt to enter the United States legally or illegally in order to find a job there and earn dollar-based wages. Many of those who succeed end up working low-paying jobs with long hours, poor working conditions, and no social security or other benefits. Presently, there are some 35 million people born in Latin America or of Latin American descent living in the United States.

On Sunday, Dec. 3, 2000, Vicente Fox, the newly-elected President of Mexico, repeated his vision of an economically strong, stable Mexico with jobs for its people and wages that eventually could compete with those in the U.S. He solicited foreign investment in his country and said that his government would study ways to make sure money from Mexican immigrants in the U.S. arrives in Mexico cheaply and safely.

During the year 2000, it is estimated that Mexican expatriates living in the United States will have sent at least 8.4 billion dollars to their homeland in regular transfers averaging around $300. That figure is expected to exceed Mexico's tourism industry revenues for the same period. According to official estimates, the money sent to Mexico by expatriates is growing by around ten percent a year.

Firms used by the migrants in the U.S. to transfer their money to family members in Latin America have come under scrutiny by the U.S. and foreign governments, due to unmistakable evidence that those firms skim off far more than the commissions which they advertise. The Procuraduría Federal de Consumidores (The Federal Consumer Affairs Procurator Office) said it would investigate how the companies—chiefly Money Gram and Western Union, two U.S. firms that work in association with Mexican businesses and banks—function, due to reports that users are cheated and charged far more for the companies' services than promised. The firms reportedly make a hefty profit of more than 1.2 billion dollars a year, mainly from the roughly 35 million people born in Latin America or of Latin American descent living in the United States.

In Latin America and in U.S. towns and cities with significant Latino communities, firms dedicated to transferring money to Latin America flood the media with ads and commercials and post thousands of posters offering “a good deal in just minutes.” However, independent investigations indicate that the deal is good only for the money transfer companies. By using variable exchange rates and paying the transfers in the currencies of the countries of destination rather than dollars, the companies end up skimming off up to 20 percent of the money sent, rather than the advertised commissions of less than seven percent that are commonly publicized.

Until the early 1990s, money transfers were monopolized by Telegrafos de Mexico, S.A. However, with the relaxation of trade and financial restrictions brought about by the North American Free Trade Agreement (NAFTA), U.S. firms entered the money transfer business. Today, U.S. firms and their Mexican associates control 90 percent of the market.

One of the serious problems related to money transfers to Latin America is that recipients are often at the mercy of the foreign associates of the U.S. firms. Many of the associates operate out of retail store establishments. Recipients are often coerced by the associates at the receiving end of the transfer to buy merchandise at inflated prices, thereby further reducing the amount effectively transferred.

Citizens living in countries where the postal system is largely free from graft and corruption would normally assume that postal money orders taken out at U.S. Post Offices and transmitted through the mail to addressees in a foreign country would be a secure and relatively inexpensive method of transferring money. This is simply not the case, as mail in Latin America is not secure. Postal money orders are frequently stolen once they enter the Latin American mail systems. Because corruption is endemic in Latin American society, cashing a stolen postal money order is really quite simple. The U.S. purchaser has no effective recourse when a money order he has mailed to a foreign country is stolen.

Money transmission is a huge problem for most Latin Americans living in the U.S. When they return to their homelands carrying large amounts of cash, they risk death at the hands of violent criminals. If they attempt international bank wire transfers, they must own a U.S. bank account, fill out complicated forms, and carry on conversations in English. Almost every migrant in the U.S. has a horror story to tell about money that never made it home. What is needed is a secure, inexpensive method of rapidly transferring money from the United States to foreign countries.

### SUMMARY OF THE INVENTION

The present invention constitutes a system and method by means of which individuals living in the U.S. or small businesses operating in the U.S. may transfer money rapidly, securely, and inexpensively to other individuals or businesses in a foreign country. The system is of particular benefit to foreign expatriates who have a need to send money to family members who still reside abroad. It also benefits foreign nationals who perform services for U.S. companies on a contract basis. The system, which is run by a managing company having associates in both the U.S. and in the foreign countries to which transfers are made, employs a network of U.S. based banks and a network of foreign based banks.

For a preferred embodiment of the system, an expatriate individual resident in the U.S. who desires to utilize the system is provided a book of deposit slips having a numerical MICR encoding which identifies both a main account belonging to an escrow company and a sub-account unique to the individual depositor. The intended recipient of transfers to be made by the depositor contemporaneously establishes or already owns an account at a branch of a foreign bank that is a participant in the money transfer network. When an expatriate desires to effect a money transfer to a particular target account at a branch of a participating bank in a foreign country, he makes a cash deposit, using his unique encoded deposit slip, at a branch of a U.S. bank that is a participant in the U.S. bank network. In conformance with standard banking practice, he is given a receipt as proof of his deposit. Though the deposited amount is credited to the main escrow account, the bank's deposit information also records the depositor's unique sub-account number and amount of his deposit.

The managing company employs an accounting system that is coupled to the accounting system of each participating U.S. bank. On a daily basis, each bank's accounting system provides deposit data related to the money transfer system—either by account information access over the Internet, or through the bank's cash management service via modem—to the managing company's accounting system, which employs proprietary software that sorts the data received from the various U.S. banks by foreign bank and individual depositor. For a preferred embodiment of the system, all main deposit accounts at participating U.S. banks are owned by an escrow company. On a daily basis, the escrow company performs a sweep of the deposit accounts at the participating U.S. banks and concentrates all deposited funds in a single master escrow bank account.

Also on a daily basis, and based on the depositor's personal information stored in a membership database that includes his specified destination for the deposited money (i.e., the target foreign country, target foreign bank, and target private account where the transferred money is to be deposited), the proprietary software generates a report which provides the managing company's agent in each foreign company with the following information: the amount to be deposited in a master bank account in the foreign country, the amount to be deposited into each main account of each participating foreign bank, the private target accounts at each foreign bank to which deposits are be made, and the amount to be deposited in each of those private accounts to which deposits are to be made. With the daily report in hand, the agent of the managing company resident in the target country purchases foreign currency with a check drawn on a dollar-denominated reserve checking account in the United States. The appropriate sum of foreign currency is then deposited in the master foreign bank account. Wire transfers are then made from the master account to the main account of each foreign bank which participates in the money transfer network. The amount transferred to each main account corresponds to the total of deposits that are to be made that day to private target accounts at branches of that bank. Deposits to private target accounts at branch banks are made using conventional deposit slips and a single check drawn on the managing company's main account. As soon as the deposit is made to an individual target account, the account owner (i.e., the intended recipient of the transfer) is entitled to withdraw the deposited funds.

The system is unique in that a person (whether an individual or some other legal entitty) makes a domestic deposit in U.S. bank, and the managing company makes a corresponding domestic deposit in a designated account in a foreign bank. This methodology has two important advantages. The first is that high fees typically associated with international wire transfers are avoided. The second is that the managing company controls the purchase of foreign currency and is, thus, not held hostage by the wiring bank to a unfavorable exchange rate. These distinct advantages allow the managing company to provide the transfer service for a reasonable flat-rate fee, regardless of the amount of money being transferred. Currently, the fee charged is five dollars per transfer. Additional profit may be made by the managing company by retaining a percentage of the difference between the foreign currency buy rate and published sell rate. Another distinct advantage of the present method and system is that an individual desiring to make a transfer from the U.S. to a foreign country may use any combination of U.S. and foreign banks which participate in the managing company's transfer network. This gives the U.S. depositor multiple options and allows foreign recipients to shop for the most favorable monthly bank account service fees. A further advantage to the present transfer system is that it is membership based, with each participating depositor having a permanent record on file with the managing company. This eliminates the need for any kind of password or code that other systems currently require for a recipient to collect transferred funds.

### DESCRIPTION OF THE DRAWINGS

FIG. 1 is a copy of a cash only deposit ticket used to implement a preferred embodiment of the bank-based, international money transfer system; and

FIG. 2 is a block schematic diagram of the bank-based international money transfer system.

### DETAILED DESCRIPTION OF THE INVENTION

The present invention constitutes a system and method by means of which large amounts of money aggregated from a large number of relatively small deposits can be transferred across international borders rapidly, securely and inexpensively. The system is of particular benefit to wage-earning foreign expatriates who have a need to send money to family members who still reside abroad, as heretofore, these expatriates have been required to pay up to 20 percent of the amount transferred in transfer fees and exchange rate discounts to companies such as Money Gram and Western Union. The system will be described in detail, with reference to the attached drawing figures.

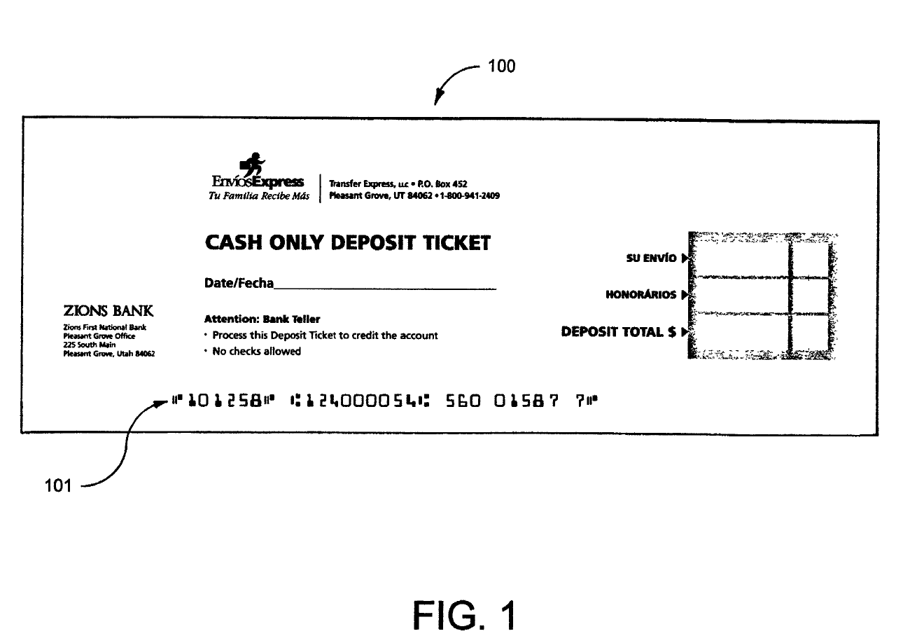

Referring now to FIG. 1, an enlarged copy of a Cash Only Deposit Ticket (CODT) 100 is shown. This CODT is similar, if not identical, to those currently being used by Envios Express LLC, an operating business in the U.S., to implement the hereinafter described money transfer system and method. This particular CODT, which is printed in both English and Spanish, may be used for transfer deposits only at Zions First National Bank. It will be noted that the bank teller is instructed to accept no checks, and to process the CODT to credit the account identified by the Magnetic Ink Character Recognition (MICR) numerical encoding 101 at the bottom thereof. It should be emphasized that the MICR numerical encoding identifies both the main escrow account at the participating bank and a sub-account unique to the individual depositor. The CODT includes spaces for noting the date of the transaction, the amount sent (su envío), the transfer fee (honorários) and the deposit total. The CODT is designed to be simple, so that little or no conversation with a bank teller is required.

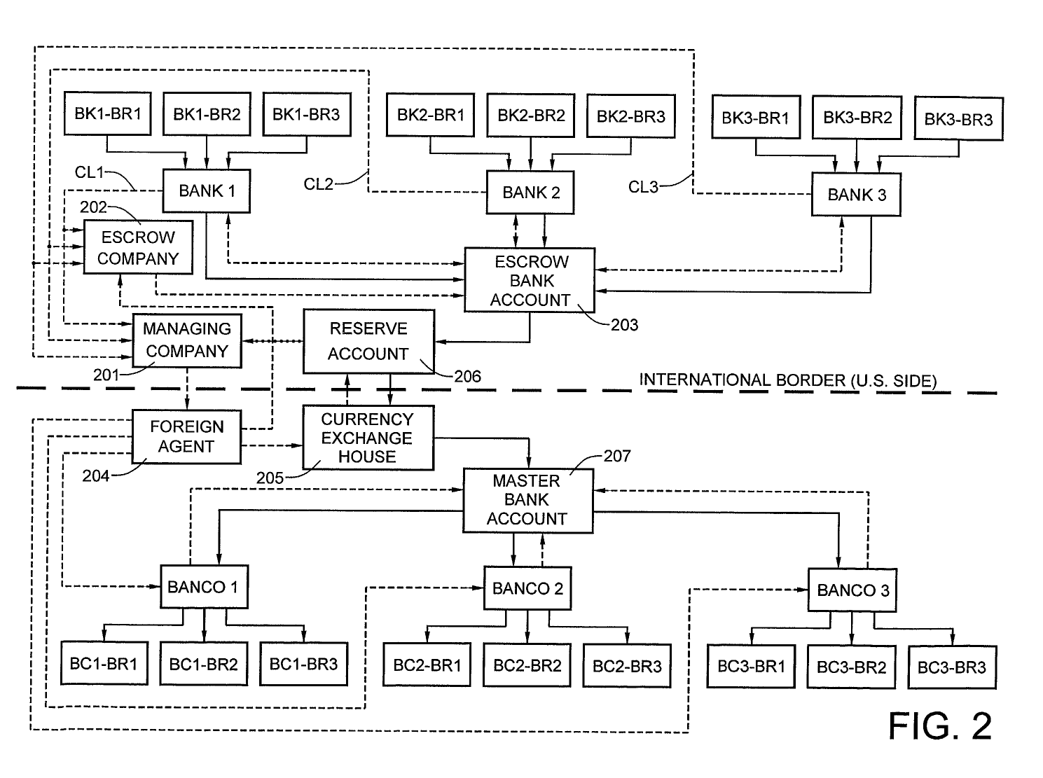

Referring now to FIG. 2, the system block diagram depicts a structure that is closely mirrored on both sides of the international border. It should be emphasized, however, that the two countries need not be contiguous for the system to function. As a matter of explanation, the solid lines indicate money flow, the single dotted line between the managing company 201 and the reserve account 205 represents revenue to the managing company 201, and dashed lines indicate information and/or directive flows. An individual having ordinary skill in the art will understand the mechanics of moving funds from one institution to another, whether through domestic wire transfers, or the movement of negotiable instruments within the banking system. The system may include any number of participating U.S. banks which are authorized to receive transfer deposits from individuals. Most of these individuals will be either foreign expatriates or individuals of foreign descent who desire to transfer funds to family members in a foreign country served by the system. In the interest of brevity, the block diagram of this figure shows only three U.S. banks (Bank 1, Bank 2, and Bank 3). Though each of the U.S. banks is shown as having three branches, they may have any number. For example, Bank 2 has branches BK2-BR1, BK2-BR2 and BK2-BR3. The system may, likewise, include any number of participating foreign banks which are the recipients of the funds deposited by individuals in the United States. Only three foreign banks are shown (Banco 1, Banco 2 and Banco 3). Though each of the participating foreign banks is shown as having three branches, they may have any number.

When an expatriate desires to effect a money transfer to a particular country served by the money transfer system, he selects both a participating U.S. bank (e.g., Bank 1, Bank 2, or Bank 3), and a participating foreign bank in the destination country (e.g., Banco 1, Banco 2, or Banco 3). The managing company 201 provides the expatriate with a book of Cash Only Deposit Tickets (CODTs) having the unique encoding heretofore described which identifies both the main escrow account at the selected U.S. bank affiliated with the transfer system and the depositor's individual sub-account with the managing company 201. The intended recipient of transfers to be made by the expatriate depositor contemporaneously establishes, or already owns, a target account at a branch of a participating foreign bank. When an expatriate desires to effect a money transfer to a designated recipient, he makes a cash deposit, using his unique encoded Cash Only Deposit Ticket (CODT), at a branch of the selected participating U.S. bank. In conformance with standard banking practice, he is given a receipt as proof of his deposit. Though the deposited amount is credited to the main escrow account, the bank's deposit information also records the unique sub-account number and amount of the individual's deposit.

For a preferred embodiment of the system, the main deposit accounts at the participating U.S. banks are owned by an escrow company 202. In addition, the escrow company 202 has a master escrow account 203, which may be located at one of the participating transfer deposit banks or some other bank.

Both the managing company 201 and the escrow company 202 have accounting systems (not shown) that are coupled to the accounting systems (also not shown) of the various participating transfer deposit banks Bank 1, Bank 2 and Bank 3 via communication lines CL1, CL2 and CL3, respectively. On a daily basis, the escrow company 202 receives deposit data related to the money transfer system—either by account information access over the Internet, or through the bank's cash management service via modem—from each of the participating transfer deposit banks Bank 1, Bank 2 and Bank 3. Following the close of each banking day, the escrow company 202, on the basis of the data received, performs a sweep of its accounts in the participating transfer deposit banks Bank 1, Bank 2 and Bank 3, thereby transferring all deposited funds deposited in those banks by individual expatriates to the master escrow account 203. The data received also provides the escrow company with a record of the amount deposited by each expatriate. The accounting system of the managing company 201 utilizes proprietary software that sorts the data received from the various U.S. banks and provides a report which correlates individual deposits made at the participating U.S. banks with the target accounts in foreign countries. On the basis of this correlation, the proprietary software generates a report which provides the following country-based information to the managing company's foreign agent over the Internet: the amount to be deposited in a master bank account in each foreign country, the amount to be deposited into each main account of each participating foreign bank in that foreign country, the account numbers of private target accounts at each foreign bank to which deposits are to be made, and the amount to be deposited in each of these numerically identified private accounts. With the daily report received over the Internet in hand, the agent 204 of the managing company resident in the target country purchases foreign currency at a currency exchange house 205 with a check drawn on a dollar-denominated reserve checking account 206 owned by the managing company 201 in the United States. It should be noted that the currency exchange house 205 may be a foreign bank (which may or may not be a participant in the money transfer system) or an independent currency exchange company. The appropriate sum of foreign currency is then deposited in the managing company's master bank account 207 for that foreign country. It is also possible to purchase the foreign currency anywhere in the world where there exists a banking relationship with the foreign bank in which the master bank account 207 is established. If a deposit is made the the master bank account 207 in the foreign currency, transfer fees are generally considerably less than for a deposit involving a currency exchange. In any case, the appropriate amounts of foreign currency are then transferred from the master account to the managing company's main account of each foreign bank (e.g., Banco 1, Banco 2, and Banco 3) which participates in the money transfer system. Domestic wire transfers are generally the simplest, least-expensive, and fastest way of making these transfers. The amount transferred to each main account corresponds to the total of deposits that are to be made that day to private target accounts at branches of that participating foreign bank. Deposits to private target accounts at bank branch offices (e.g., BC1-BR1, BC1-BR2, and BC1-BR3 are branches of Banco 1) are made using conventional deposit slips and a single check drawn on the managing company's main account with that bank. As each deposit is made, a sealed receipt is obtained from the bank. As soon as the deposit is made to an individual target account, the account owner (i.e., the intended recipient of the transfer) is entitled to withdraw the deposited funds. All deposit receipts from the day's transactions are electronically scanned and sent to the escrow company 202, which after performing at least a partial audit of the receipts, releases funds from the master escrow account 203 to the reserve account 206. The amount released includes a flat-rate transfer fee for each transaction made by an expatriate depositor. The fees are used to defray operating costs of the money transfer system. Amounts in excess of costs are profit to the managing company 201. Additional profit may be made by the managing company by retaining a percentage of the difference between the foreign currency buy rate and published sell rate.

The advantages of the heretofore described system are many and include the following:

(1) There is no need for a U.S. depositor to own a U.S. bank account;

(2) The high fees typically associated with international wire transfers are avoided;

(3) The managing company is able to purchase foreign currency for deposit in individual accounts in the foreign country at the most favorable exchange rate available;

(4) Any amount of money may be transferred for a small flat-rate fee;

(5) The depositor and his intended recipient enjoy maximum flexibility with regard to the selection of a depository bank in the U.S. and a target bank in the foreign country;

(6) The intended recipient is not required to provide a password or code to receive the transferred funds, as is the case with most other money transfer systems now in place;

(7) Deposits are made at an FDIC-insured institution and are made directly into an FDIC-insured account belonging to a government registered bonded escrow company;

(8) The possibility of human error in routing the transfer is virtually eliminated through the use of MICR encoded deposit tickets, which are reliably read by the bank's automated equipment;

(9) The deposit transaction requires no dialog with the attending bank teller, which enables non-English speaking depositors to conveniently utilize the system;

(10) Recipients of money transfers need not travel to an often distantly located agent to collect the transferred funds;

(11) The recipient need not risk assault by carrying the transferred cash on his/her person;

(12) The managing company controls the entire transfer process, which greatly reduces the opportunities for graft and corruption; and

(13) Information related to individual transfers is immediately available with a single telephone call.

Although only several embodiments of the invention have been heretofore described, it will be obvious to those having ordinary skill in the art that changes and modifications may be made thereto without departing from the scope and the spirit of the invention as hereinafter claimed. For example, although banks are named as the depository institutions for initiating transfers in the U.S., other financial institutions, such as savings and loan organizations could also be used, either exclusively or in combination with the different banks. Thus, the term “bank” should be construed loosely. The same is true within the foreign countries. Any financial institution which permits individual deposit accounts could function as the ultimate destination of the money transfers.

What is claimed is:

1. A method of transferring money from the U.S. to a foreign country without the use of an international bank wire transfer, said method comprising the steps of:
establishing a managing company to administer the process, said company having at least one agent in the U.S. and at least one agent in a foreign country that is the target of money transfers;
providing to a potential transferor at least one printed deposit slip having an encoding which identifies an account associated with the managing company at a U.S. bank and a sub-account associated with the transferor, so that the transferor may make a cash deposit at a branch of the U.S. bank for transfer to the foreign country;
depositing a corresponding amount in the currency of the foreign country into a target account identified by the transferor and owned by his designated transferee at a bank in the foreign country, the foreign deposit being made by the managing company, using target account information from its files and deposit information provided by the U.S. bank, the latter information including the amount of deposit and the associated subaccount identifier encoded on the deposit slip.

2. The money transfer process of claim 1, wherein the account associated with the managing company is owned by an independent escrow company.

3. The money transfer process of claim 2, which further comprises the step of establishing a reserve account at a U.S. financial institution, said reserve account providing the funds for the purchase of the currency of the foreign country.

4. The money transfer process of claim 3, wherein said currency of the foreign country is purchased within the foreign country at a favorable exchange rate with a check drawn on the U.S. reserve account.

5. The money transfer process of claim 3, wherein said currency of the foreign country is purchased in a country outside the foreign country at a favorable exchange rate with a check drawn on the U.S. reserve account.

6. The money transfer process of claim 4, wherein an account associated with the managing company is established at each of multiple U.S. banks for the deposit of cash to be transferred, and a main account is established at each of multiple banks in the foreign country for the receipt of currency of the foreign country, and from which amounts corresponding to transfer deposits made in the U.S. can be conveyed to individual transferee accounts at that bank.

7. The money transfer process of claim 6, which further comprises the step of establishing a master account in the foreign country, said master account receiving all currency periodically purchased in the foreign country, and providing a source from which funds may be transferred into the main accounts at banks within the foreign country.

8. The money transfer process of claim 7, which further comprises the step of establishing a master escrow account at a bank in the U.S., and wherein the escrow company periodically makes a sweep of its U.S bank accounts which are associated with the managing company in order to concentrate all funds deposited thereto within a single U.S. account.

9. The money transfer process of claim 8, wherein funds are transferred from the master escrow account to the reserve account upon proving to the escrow company that a corresponding amount has been deposited to the appropriate individual accounts in the foreign country.

10. The money transfer process of claim 9, wherein the managing company periodically receives deposit information from all of the accounts owned by the escrow company and generates a report for its at least one agent in the foreign country, said report containing the following information:
the amount to be deposited in the master bank account in the foreign country;
the amount to be deposited into each main account at participating banks in the foreign country;
the account numbers of transferee accounts at the participating banks to which transfer deposits are to be made; and
the amount to be deposited in each of these numerically identified transferee accounts.

11. A system for transferring money from the U.S. to a foreign country without the use of an international bank wire transfer, said system comprising:
a managing company which administers the system, said company having at least one agent in the U.S. and at least one agent resident in at least one foreign country that is the target of money transfers;
a transfer deposit account associated with the managing company established at each of a plurality of participating U.S. banks, each of said accounts set up to receive transfer deposits from transferors who have registered with the managing company and provided it information about their intended foreign-resident transferees, and who have received at least one deposit slip which identifies both a transfer deposit account at a specific participating U.S. bank and a sub-account associated with the transferor;
a main account associated with the managing company established at each of a plurality of participating banks in said at least one foreign country, each bank having a plurality of individual target accounts belonging to transferees designated by the transferors; and
a reserve account at a U.S. financial institution containing funds with which said at least one agent resident in the foreign country can purchase currency of the foreign country to deposit into the various main accounts, the amount deposited into each main account corresponding to amounts deposited in the U.S. transfer deposit accounts by transferors who have identified transferees with target accounts at that foreign bank.

12. The money transfer system of claim 11, wherein each of the transfer deposit accounts at U.S. banks is owned by an escrow company.

13. The money transfer system of claim 12, which further comprises a master escrow account at a bank in the U.S., into which are periodically deposited all funds deposited within the various transfer deposit accounts.

14. The money transfer system of claim 12, wherein funds are transferred from the master escrow account to the reserve account upon proving to the escrow company that a corresponding amount has been deposited to appropriate individual accounts in the foreign country.

15. The money transfer system of claim 12, which further comprises a master bank account into which all foreign currency purchased by said at least one agent resident in the foreign country is deposited prior to its transfer to the various main bank accounts in the foreign country.

16. The money transfer system of claim 11, which further comprises an accounting system that is utilized by the managing company to generate a periodic report, based on both transfer deposit information received from the participating U.S. banks and registration information provided by transferors, for its at least one foreign agent in each foreign country in which it operates, said report containing the following information:
the amount to be deposited in the master bank account in that foreign country;
the amount to be deposited into each main account at participating banks in that foreign country;
the account numbers of transferee accounts at the participating banks to which transfer deposits are to be made; and
the amount to be deposited in each of these numerically identified transferee accounts.

17. The money transfer system of claim 11, which further comprises a data link between each of the participating U.S. banks and the escrow company, each data link providing the escrow company with the following periodic information:
the total amount deposited during the period in the transfer deposit account at the reporting bank; and
the total amount deposited by each transferor.

18. The money transfer system of claim 13, wherein the escrow receives deposit information related to the transfer deposit account at each participating U.S. bank, which includes at least:
the total amount deposited in each transfer deposit account; and
the amount deposited by each transferor.

19. A method of transferring money from the U.S. to a target foreign country without the use of an international bank wire transfer, said method comprising the steps of:
establishing a deposit account at each of multiple participating banks within the United States for the purpose of receiving cash-only deposits from persons desiring to make an international transfer of money, said deposit accounts owned by a single escrow company;
establishing a reserve account at a U.S. financial institution;
providing to each potential transferor at least one printed deposit slip which identifies both a specific deposit account at a participating U.S. bank and sub-account identified with the transferor, so that deposits made by the transferor are traceable to him;
establishing a main account at each of multiple banks in each target foreign country;
creating a database which includes the name and other personal information of each transferor, as well as at least one designated transferee in a foreign country having a private account at one of the target foreign banks;
establishing a managing company to administer the money transfer process, said managing company having at least one agent in each target foreign country, said company also having an accounting system which receives data from each participating U.S. bank, relating to deposits made to the deposit accounts at that bank, said accounting system generating a report for each target foreign country, said report being transmitted to said at least one agent in that country and specifying the amount to be deposited into the main account at each target bank in the foreign country, the account numbers of transferee accounts at the target banks to which transfer deposits are to be made, and the amount to be deposited in each of these numerically identified transferee accounts;
purchasing an amount of currency of each target foreign country with a check drawn on the U.S. reserve account, said amount corresponding to the total amount of U.S. deposits which are to be directed to that target foreign country;
depositing foreign currency in the main account at each foreign bank in an amount sufficient to cover funds deposited in the U.S. which are directed to private accounts at that foreign bank; and
directing an appropriate amount of funds from each main account to each transferee account.

20. The method of transferring money of claim 19, which further comprises the step of establishing a master escrow account at a bank in the U.S., and wherein the escrow company periodically makes a sweep of its deposit accounts at the participating U.S bank accounts, in order to concentrate all funds deposited thereto within a single U.S. account.

21. The method of transferring money of claim 20, wherein funds are transferred from the master escrow account to the reserve account upon proving to the escrow company that a corresponding amount has been deposited to appropriate individual accounts in the foreign country.

22. The method of transferring money of claim 19, which further comprises the steps of:
establishing a master account in each target foreign country;
depositing foreign currency purchased for a particular foreign country in that country's respective master account; and
transferring appropriate amounts of foreign currency from the master account to the main account at each bank in that foreign country.
